(19) United States
(12) Patent Application Publication
(10) Pub. No.: US 2012/0216240 A1
(43) Pub. Date: Aug. 23, 2012

(54) PROVIDING DATA SECURITY THROUGH DECLARATIVE MODELING OF QUERIES

(75) Inventors: Ramakanthachary Gottumukkala, Sammamish, WA (US); Vijay Kurup, Sammamish, WA (US); Srinivasan Parthasarathy, Redmond, WA (US); Edvardas Budrys, Carnation, WA (US); Tanmoy Dutta, Sammamish, WA (US); Arindam Chatterjee, Redmond, WA (US)

(73) Assignee: MICROSOFT CORPORATION, Redmond, WA (US)

(21) Appl. No.: 13/029,616

(22) Filed: Feb. 17, 2011

(51) Int. Cl. G06F 17/00

(52) U.S. Cl. 726/1

(57) ABSTRACT

Data security is implemented through a query based policy constraining a primary table. Nested tables inherit the security policy by implementing the policy queries of the primary table. Operations on nested tables such as join actions execute the security policy queries once due to inheritance from the primary table therefore optimizing query modeling. A security policy may respond to a context or a role by executing queries responsive to the context.

### BACKGROUND

With the proliferation of computerized automation of processes in every aspect of life, data storage and processing have become a major component of networked systems handling financial and other transactions. In such systems, data may be entered, modified, or deleted from a number of sources. The same data may be maintained in multiple data stores in same or different formats, and a data store may have to pick up or synchronize changes to data based on changes in a different store. Various data stores from simple tables to complicated databases may be maintained and synchronized as new entries or modifications are made by different sources. The changes may be synchronized at regular intervals. In many cases, the databases are partially or completely related.

Access to data may be complicated by the need to secure various components of a data store. Schemas and tables in a data store may have to be secured from unauthorized access separately or through a common scheme. In addition, it may be desirable to expose only certain content within a data structure. Controlling per user access on data structure granularity may slow down available resources, complicate implementation, and obscure maintenance of a modern data store.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing data security through a query based security policy constraining a primary table. Access constraints may be inherited by any nested table through the use of the policy. A policy aware framework may simplify optimization of access constraint queries on subsequent tables. Additionally, the policy may be applied based on a context or a role of a user.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a diagram illustrating example components of a system providing data security through declarative modeling of queries;

FIG. 2 illustrates example concept diagram of query based data security implementation;

FIG. 3 illustrates an example data store diagram according to some embodiments;

FIG. 4 is an example tree list illustrating components of a security policy implementation;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process of providing data security through query based policy execution according to embodiments.

### DETAILED DESCRIPTION

As briefly described above, data security may be implemented through a query based security policy constraining a primary table. Nested tables may inherit access restrictions through the execution of the policy. A policy aware framework may simplify optimization of access restriction queries on additional tables. Furthermore, the policy may be applied based on a context or a role of a user. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable storage media.

Throughout this specification, the term “platform” may be a combination of software and hardware components for providing data security through policy based queries or similar environment, where embodiments may be implemented. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

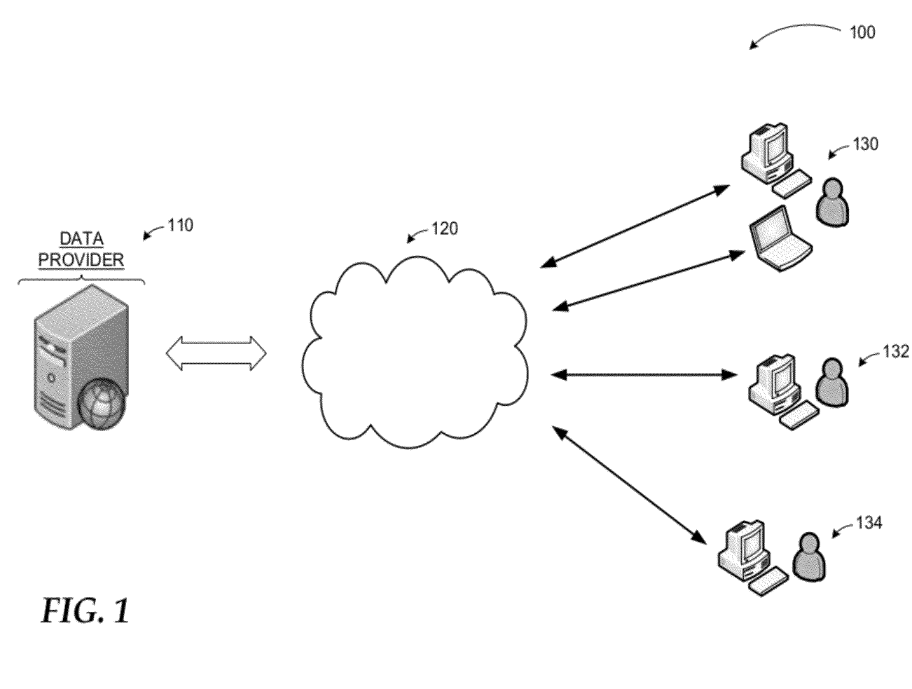

FIG. 1 is a diagram illustrating example components of a system providing data security through declarative modeling of queries. In diagram 100, the server 110 may host a data provider employing query based access constraint policy via network 120. The network 120 may be a local network or may be an external entity such as an internet based infrastructure. It may provide wired or wireless connectivity. Network nodes may connect to each other through unsecured or secured connectivity. An example of a secured connectivity may be a Virtual Private Network (VPN) established among the network nodes with the use of encrypted communications.

The server 110 may be associated with a data provider such as a data store communicating with clients employing a variety of protocols and models, an example of which may be the Component Object Model (COM). The data store may be a database. Another example may be a data store containing user data or a plurality of data stores addressing massive storage requirements in a distributed service setting such as a cloud based solution. Additionally, the data provider may provide data to multiple client devices (e.g. client 130) or multiple users to access the same service simultaneously (e.g. clients 132, 134).

In an example embodiment, the client 130 may be provide access to the data store through a client application on a desktop or a mobile system. The client application may enable the user, such as a developer, to implement a security policy into the data store. The policy may be programmed by query statements constraining access to data store structures such as tables. An example may be a query statement defining a time period when a table may be updated.

In an example scenario, the clients 132, 134 may provide access to the data store through client application. The client application may enable a user to retrieve data. The data store may enforce the security policy defined by queries to constraint data access to the user. The constraint may be time based or role based. The implemented constraints may not be limited to those described and may involve any operation in regards to data store access.

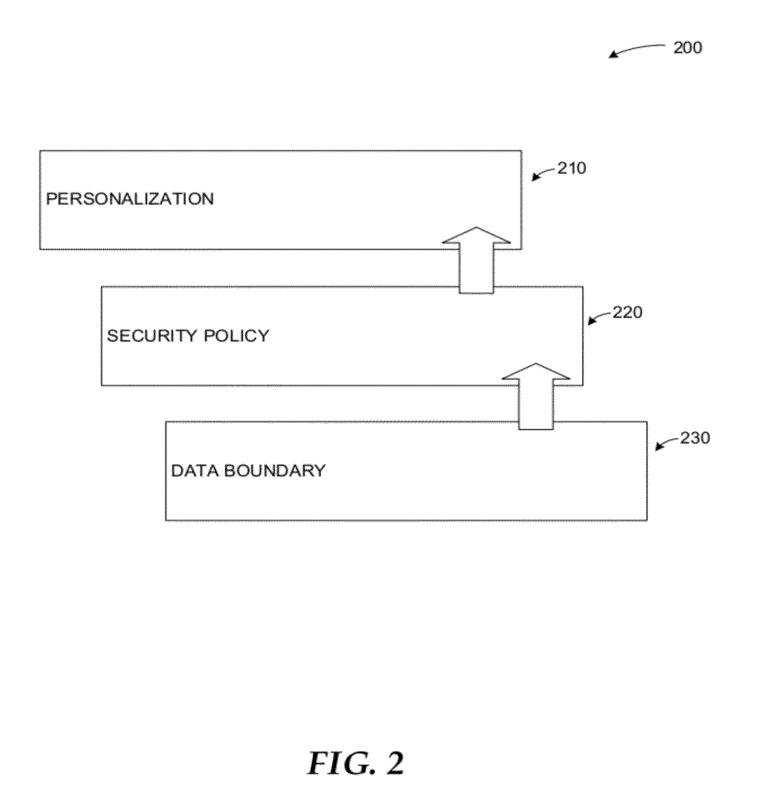

FIG. 2 illustrates example concept diagram 200 of query based data security implementation. A system according to embodiments employs a security policy based on queries to constraint access to data structures. Data structures such as data store tables may be constrained by the same policy through inheritance of the security policy. In an example scenario, optimization of queries may be simplified due to inheritance of policy queries on subsequent data store tables. Additionally, the role of a user may trigger which policy measures to implement to constraint access to the data store tables.

Diagram 200 illustrates some example concepts in providing data security through a query based policy implementation according to embodiments. Implementation of a security policy through queries addresses three areas of data security. The policy queries may define the data boundary 230 at system kernel level. An example may be access to a specific data store only. Additionally, access may be further restricted by defining available system resource utilization and a scheme to manage bottlenecks at system level.

The queries may also define a security policy 220 implementing constraints to data structures in a data store such as a database. An example may be a query constraining access to a range of data. The range may be based on a time based constraint. The range may enable a user to only access data available for the current year, for example. Constraining access to current year data may enforce organization constraint policy to prevent unintentional modifications of prior information such as tax related financial information, etc.

In another example, the security policy may implement personalization 210. The security policy may execute a subset of queries according to user's role. In an example, a framework executing the security policy may determine a user's identification and role in the data system. According to user's attributes or permission level, the security policy may restrict the user to read only access. If the user has edit privileges, the security policy may execute queries enabling features to edit data structures available to the user. Additionally, the security policy may be implemented by a developer through the use of an Application Programming Interface (API).

In yet another example, modeling of a security policy through queries may allow a user such as a developer to constrain multiple tables using the same queries for a primary table. The additional tables' relations to the primary table may enable the additional tables to inherit the security policy queries. In an example scenario, a developer may want to place a constraint tables A, B, and C that are related to table X allowing access to a subset of records in table X. Using a framework to describe a security policy, the developer may define a query returning the subset of records from table X by a user. The developer then may choose tables A, B, and C as constrained tables. The developer may specify the relation between A and X, B and X, and C and X. Once the relations are defined, any time a user selects data from tables A, B, and C, the constraint is applied to prevent the user from accessing any data not accessible on table X. Additionally, the query may contain identification variables such as “CurrentUser”, “CurrentEmployeeID”, “CurrentCustomerAccount”, etc. Using the identification variables, the developer may write a single query returning different results based on the user identification executing the query at runtime to determine which subset of the queries to execute.

The above example may allow the developer to define a single security policy for all the tables in a data system constrained by the single policy. The single policy may help in policy update/maintenance due to a single update interface compared to multiple interfaces. Queries in constrained tables are modified automatically upon any change in policy queries.

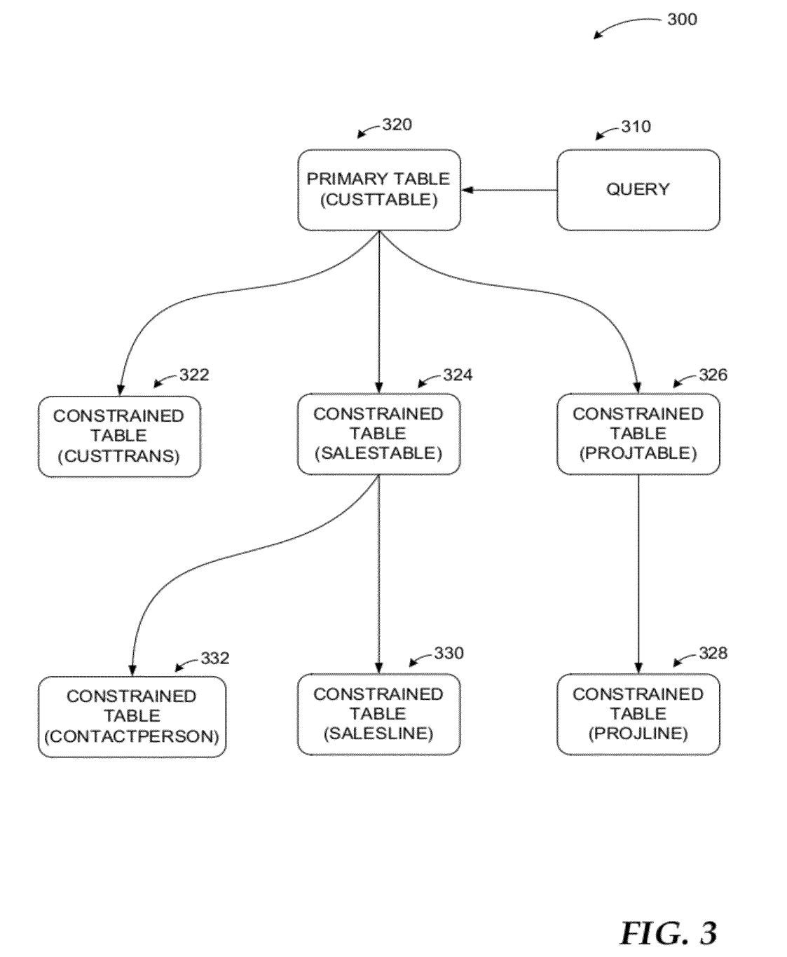

FIG. 3 illustrates an example data store diagram 300 according to some embodiments. In an example data store schema, modeling security policy based on queries may allow a developer to define nested constrained tables. The developer may define a relation between each nested constrained table and its parent table such as a primary table having the security policy.

In an example, queries 310 may define the security policy for primary table CUSTTABLE 320. The primary table may have defined relations with constrained nested tables CUSTTRANS 322, SALESTABLE 324, and PROJTABLE 326 each of which inherits the primary tables security policy queries constraining them to the policy. In addition, nested constrained tables may have additional level of nesting such as the relations between SALESTABLE 324 and CONTACTPERSON 332 and SALESLINE 330, or PROJTABLE 326 and PROJLINE 328.

Inheritance of query based security policy from the primary table according to some embodiments allows constraint to propagate across multiple levels of related tables using the same policy. Enforcing the same policy may ensure secondary level nested tables to be protected during access from forms through the parent table. In addition, policy inheritance may protect the nested tables during direct access through services or plug-ins by enforcing the security constraints of the parent table.

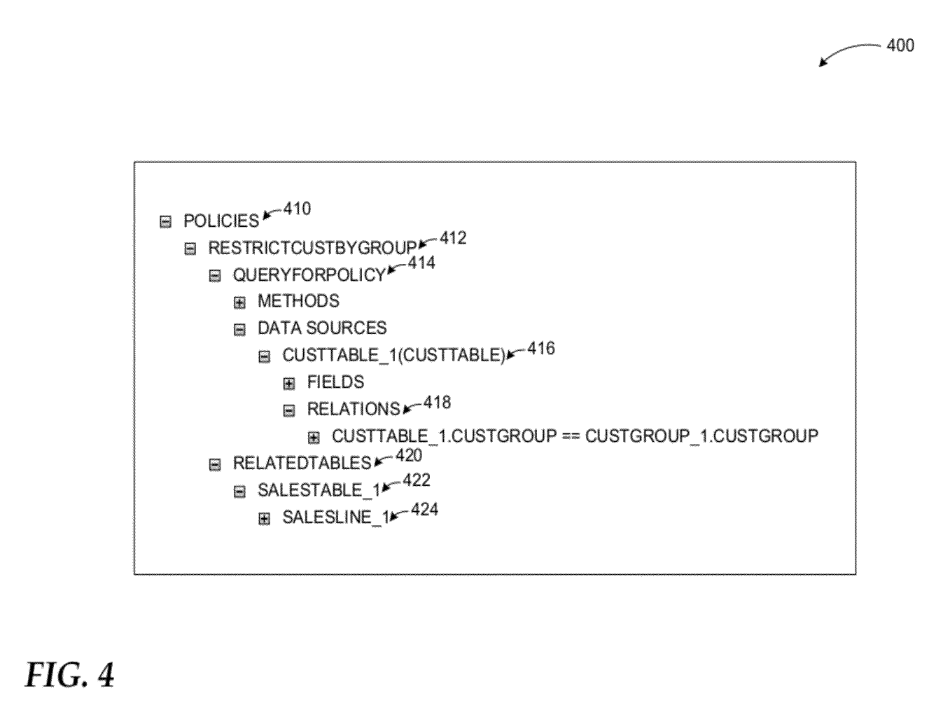

FIG. 4 is an example tree list illustrating components of a policy implementation. In diagram 400, a framework may be used to access and manage security policies. A framework aware of policy inheritance may optimize a generated query by not duplicating the same policy when joining two nested tables. In an example, a policy container 410 may restrict customers by groups 412 using multiple queries for policy 414. A primary table CUSTTABLE_1 416 may have query constraints defined by relations 418 specifying limits on records.

In related tables 420, nested tables SALESTABLE_1 422 and SALESLINE_1 424 may inherit the constraints of the CUSTTABLE_1 416. The framework knowledge of the inheritance enables the framework to utilize the queries in the primary table in a join action to restrict the nested tables. As a result, the framework may optimize the join query and apply the query once in the “WHERE” clause due to inheriting the restrictive security policy queries.

Additionally, security policy based queries may be applied based on a context. A developer may define the context based on a role in the data system. If the policy context matches that of the role, the framework may automatically apply the policy. An example may be the execution of policy queries upon determination of user's identity and privileges such as constraining read access to data rows based on user's rights. In addition, the developer may have a security policy applied based on the context by a property setting on the policy. An example may be a duration property where a security policy is implemented during certain time periods.

The systems and implementations of providing data security through declarative modeling of queries discussed above are for illustration purposes and do not constitute a limitation on embodiments. Query based security policies may be implemented by frameworks and APIs. Queries may constraint access to all data structures of data store such as a database. Policies may be implemented employing other modules, processes, and configurations using the principles discussed herein.

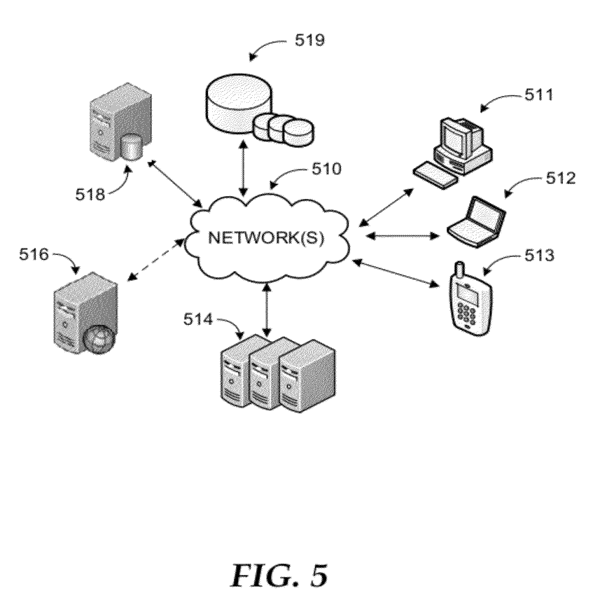

FIG. 5 is an example networked environment, where embodiments may be implemented. Query based data security policies may be implemented via software executed over one or more servers 514 or a single server (e.g. web server) 516 such as a hosted service. The platform may communicate with client applications on individual computing devices such as a smart phone 513, a laptop computer 512, or desktop computer 511 (‘client devices’) through network(s) 510.

As discussed above, a framework may implement a query based data security policy on a data store. Queries implementing the security policy may be executed to constrain data access to the client devices 511-513. Queries may be optimized by the framework for any nested constrained tables.

Client devices 511-513 may enable access to applications executed on remote server(s) (e.g. one of servers 514) as discussed previously. The server(s) may retrieve or store relevant data from/to data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to provide security policy through queries. Furthermore, the networked environments discussed in FIG. 5 are for illustration purposes only. Embodiments are not limited to the example applications, modules, or processes.

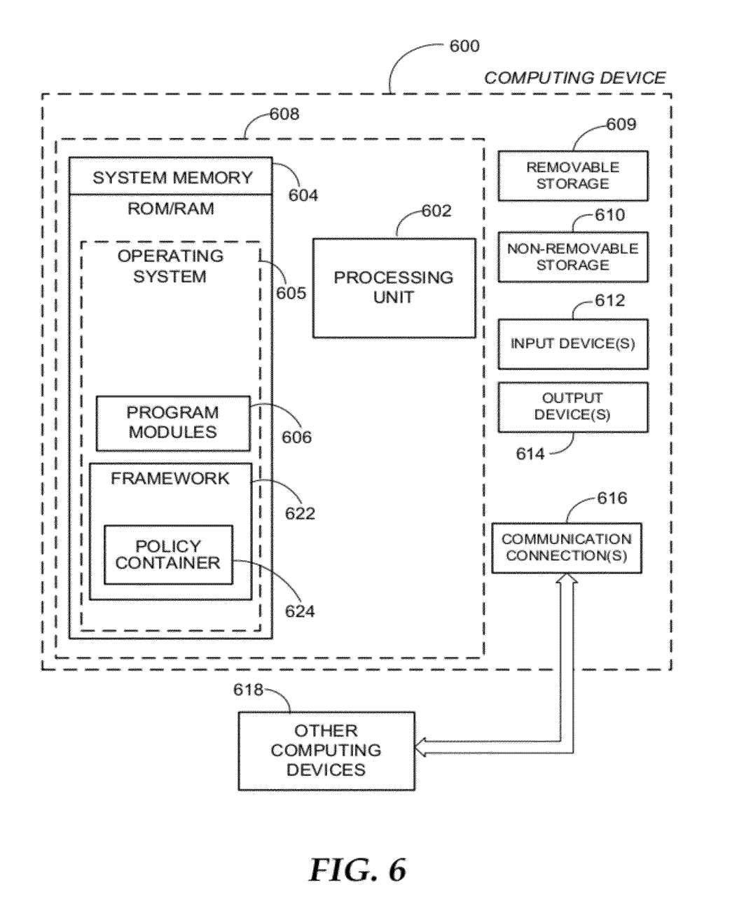

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be an implementation of query based security policy and include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® operating systems from MICROSOFT CORPORATION of Redmond, Wash. The system memory 604 may also include one or more software applications such as program modules 606, framework 622, and policy container module 624.

Framework 622 may be part of a service that provides a security policy based on queries, etc. Policy container module 624 may implement access constraints to data structures on data store such as a database. Nested tables may inherit constraints of the primary table. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 618 may include computer device(s) that execute communication applications, storage servers, and comparable devices. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

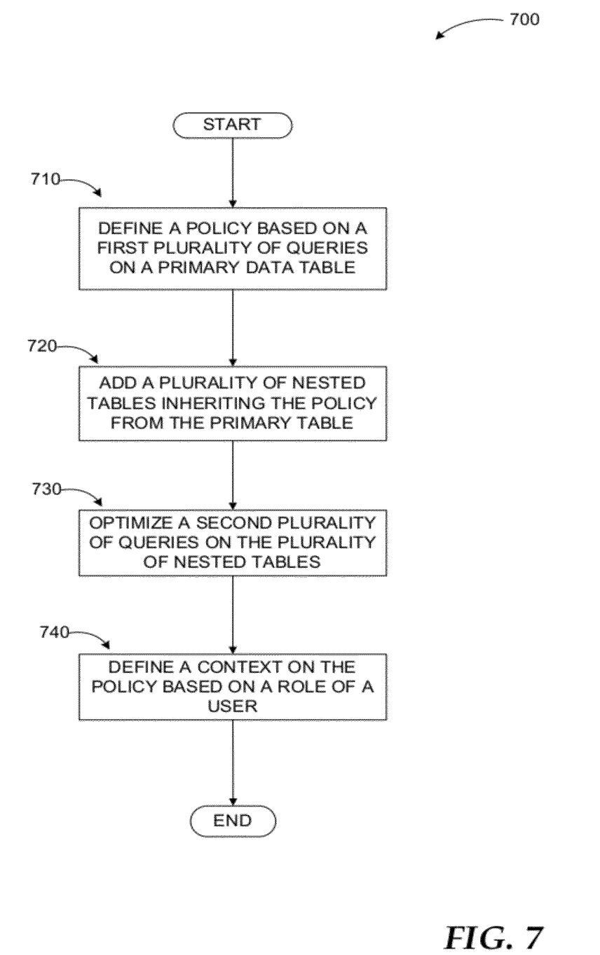

FIG. 7 illustrates a logic flow diagram for process 700 of a process of providing data security through query based policy execution according to embodiments. Process 700 may be implemented by a data server providing data services to clients.

Process 700 begins with operation 710, where a framework may define a security policy based on a set of queries on a primary data table. From that point on, the executed queries may restrict the user's access to data based on the set policy by the queries. At operation 720, a developer may add a plurality of nested tables inheriting the policy from the primary table. When accessing the nested tables, either directly or through a parent table, the inherited policy queries automatically constrain data access to the nested tables. At operation 730 additional queries such as a join action are optimized because the policy queries are applied once and are not duplicated. Additionally, security policy may react differently based on context such as a role of a user and execute certain queries to grant access data for specified user in operation 740.

The operations included in process 700 are for illustration purposes. Providing data security through query based security policy according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part by a computing device providing data security, the method comprising:
defining a security policy based on a first plurality of queries on a primary data table;
adding at least one nested table inheriting the security policy from the primary table;
optimizing a second plurality of queries on the at least one nested table by inheriting the first plurality of queries for the security policy; and
evaluating a context against the security policy.

2. The method of claim 1, wherein the context is a user's role.

3. The method of claim 2, wherein the user's role determines which subset of the first plurality of queries to execute during access to the primary table.

4. The method of claim 2, wherein the user's role determines which subset of the first plurality of queries to execute during access to the at least one nested table.

5. The method of claim 1, wherein the security policy is defined through a framework.

6. The method of claim 1, wherein the security policy is defined through an Application Programming Interface (API).

7. The method of claim 1, wherein another table nested within the at least one nested table inherits the security policy.

8. The method of claim 7, wherein the first plurality of queries include a plurality of identification variables.

9. The method of claim 8, wherein the plurality of identification variables are matched to a user to determine which subset of the plurality of queries to execute at runtime.

10. The method of claim 1, wherein the security policy is one of a time-based and a role-based security policy.

11. A data server providing data security, the server comprising:
a memory;
a processor coupled to the memory, the processor executing an application in conjunction with instructions stored in the memory, wherein the application is configured to:
define a security policy based on a first plurality of queries through a framework on a primary data table;
add a plurality of nested tables inheriting the security policy from the primary table;
optimize a second plurality of queries on the plurality of nested tables by inheriting the first plurality of queries for the security policy; and
evaluate a role against the security policy to determine which subset of the first plurality of queries to execute for providing access to the primary table.

12. The data server of claim 11, wherein the security policy defines a data boundary at a system kernel level.

13. The data server of claim 12, wherein the data boundary is an access constraint based on an available system resource utilization.

14. The data server of claim 12, wherein the data boundary is an access constraint based on a scheme to manage bottlenecks.

15. The data server of claim 11, wherein the first plurality of queries restrict access to a range of data.

16. The data server of claim 15, wherein the range is determined by a time-based constraint.

17. The data server of claim 11, wherein the security policy is inherited by a secondary table through a relation of the secondary table with the primary table.

18. A computer-readable storage medium with instructions stored thereon providing data security, the instructions comprising:
defining a security policy based on a first plurality of queries through a framework on a primary data table;
adding a plurality of nested tables inheriting the security policy from the primary table through a relation with the primary table;
optimizing a second plurality of queries on the plurality of nested tables by inheriting the first plurality of queries for the security policy; and
evaluating a user role-based context against the security policy to determine which subset of the first plurality of queries to execute during access to the primary table, wherein the user role is derived from at least one identification variable included in the first plurality of queries.

19. The computer-readable storage medium of claim 18, wherein the security policy protects the plurality of nested tables during a direct access to the plurality of nested tables.

20. The computer-readable storage medium of claim 19, wherein the context is defined by a property setting on the security policy.
